(19) United States
(12) Patent Application Publication
(10) Pub. No.: US 2010/0124313 A1
(43) Pub. Date: May 20, 2010

(54) METHODS AND APPARATUS TO PERFORM DOWNHOLE X-RAY FLUORESCENCE

(75) Inventor: GO FUJISAWA, SAGAMIHARA-SHI (JP)

Correspondence Address: SCHLUMBERGER K.K., 2-2-1 FUCHINOBE, SAGAMIHARA-SHI, KANAGAWA-KEN, 229-0006, JP

(73) Assignee: SCHLUMBERGER TECHNOLOGY CORPORATION, Sugar Land, TX (US)

(21) Appl. No.: 12/271,921

(22) Filed: Nov. 16, 2008

(51) Int. Cl. G01N 23/223

(52) U.S. Cl. 378/45

(57) ABSTRACT

Example methods and apparatus to perform downhole x-ray fluorescence to detect sulfur in formation fluids are disclosed. A disclosed example downhole x-ray fluorescence apparatus comprises a flowline comprising a flowline wall, an x-ray source, a boron carbide crystal window in the flowline wall to allow x-rays emitted by the x-ray source to pass into a formation fluid in the flowline, and a detector to measure a value representative of a fluorescence of the formation fluid in response to the emitted x-rays.

### FIELD OF THE DISCLOSURE

This disclosure relates generally to sulfur detection and, more particularly, to methods and apparatus to perform downhole x-ray fluorescence to detect sulfur.

### BACKGROUND

Wellbores are drilled to, for example, locate and produce hydrocarbons. During a drilling operation, it may be desirable to perform evaluations of the formations penetrated by the wellbore. In some cases, a drilling tool is removed and a wireline tool is then deployed into the wellbore to test and/or sample the formation and/or fluids associated with the formation. In other cases, the drilling tool may be provided with devices to test and/or sample the surrounding formation and/or formation fluids without the need to remove the drilling tool from the wellbore. These samples or tests may be used, for example, to characterize hydrocarbons and/or detect the presence of elements, such as sulfur, in formation fluids.

Formation evaluation often requires that fluid(s) from the formation be drawn into the downhole tool for testing, evaluation and/or sampling. Various devices, such as probes, are extended from the downhole tool to establish fluid communication with the formation surrounding the wellbore and to draw fluid(s) into the downhole tool. Fluid(s) passing through the downhole tool may be tested and/or analyzed to determine various downhole parameters and/or properties while the downhole tool is positioned in situ, that is, within a wellbore. Various properties of hydrocarbon reservoir fluids, such as viscosity, density and phase behavior of the fluid at reservoir conditions, and/or a presence and/or absence of elements, may be used to evaluate potential reserves, determine flow in porous media and design completion, separation, treating, and metering systems, among others.

Additionally, samples of the fluid(s) may be collected in the downhole tool and retrieved at the surface. The downhole tool stores the formation fluid(s) in one or more sample chambers or bottles, and retrieves the bottles to the surface while, for example, keeping the formation fluid pressurized. These fluids may then be sent to an appropriate laboratory for further analysis, for example. Typical fluid analysis or characterization may include, for example, composition analysis, fluid properties and phase behavior, and/or detection of elements. Additionally or alternatively, such analysis may be made at the wellsite using a transportable lab system.

### SUMMARY

Example methods and apparatus to perform downhole x-ray fluorescence to detect sulfur are disclosed. A disclosed example downhole x-ray fluorescence apparatus includes a flowline comprising a flowline wall, an x-ray source, a boron carbide crystal window in the flowline wall to allow x-rays emitted by the x-ray source to pass into a formation fluid in the flowline, and a detector to measure a value representative of a fluorescence of the formation fluid in response to the emitted x-rays

A disclosed example method to detect sulfur in a formation fluid includes trapping the formation fluid in a flowline, the flowline having a boron carbide crystal window, passing x-rays through the boron carbide crystal window into the trapped formation fluid, measuring a value representative of a fluorescence of the trapped formation fluid in response to the x-rays, and determining whether the sulfur is present in the formation fluid based on the measured value.

### BRIEF DESCRIPTION OF THE DRAWINGS

FIG. 1 is a schematic, partial cross-sectional view of a downhole wireline tool suspended from a rig and having an internal x-ray fluorescence assembly with the wireline tool.

FIG. 2 is a schematic, partial cross-sectional view of a downhole drilling tool suspended from a rig and having an internal x-ray fluorescence assembly with the downhole drilling tool.

FIG. 3 is a cross-sectional view of an example manner of implementing the example x-ray fluorescence assembly of FIGS. 1 and 2.

FIG. 4 illustrates an example process that may be carried out downhole to perform sulfur detection, and/or to implement the example x-ray fluorescence assembly of FIGS. 1-3.

FIG. 5 is a schematic illustration of an example processor platform that may be used and/or programmed to carry out the example process of FIG. 4 and/or to implement any of all of the methods and apparatus disclosed herein.

Certain examples are shown in the above-identified figures and described in detail below. In describing these examples, like or identical reference numbers may be used to identify common or similar elements. The figures are not necessarily to scale and certain features and certain views of the figures may be shown exaggerated in scale or in schematic for clarity and/or conciseness. Moreover, while certain preferred embodiments are disclosed herein, other embodiments may be utilized and structural changes may be made without departing from the scope of the invention.

### DETAILED DESCRIPTION

The example downhole methods and apparatus disclosed herein provide certain advantages for downhole and/or wellbore applications that include, but are not limited to, an ability to withstand and/or operate in the environmental conditions present within a wellbore. More particularly, the example x-ray fluorescence apparatus and methods described herein are able to withstand and/or remain operable while being subjected to pressures as high as 15,000 pounds per square inch (psi) and/or temperatures as high as 150 degrees Celsius (C.). Under such downhole conditions, conventional and/or traditional x-ray fluorescence devices would fail and/or become damaged and, thus, become inoperable.

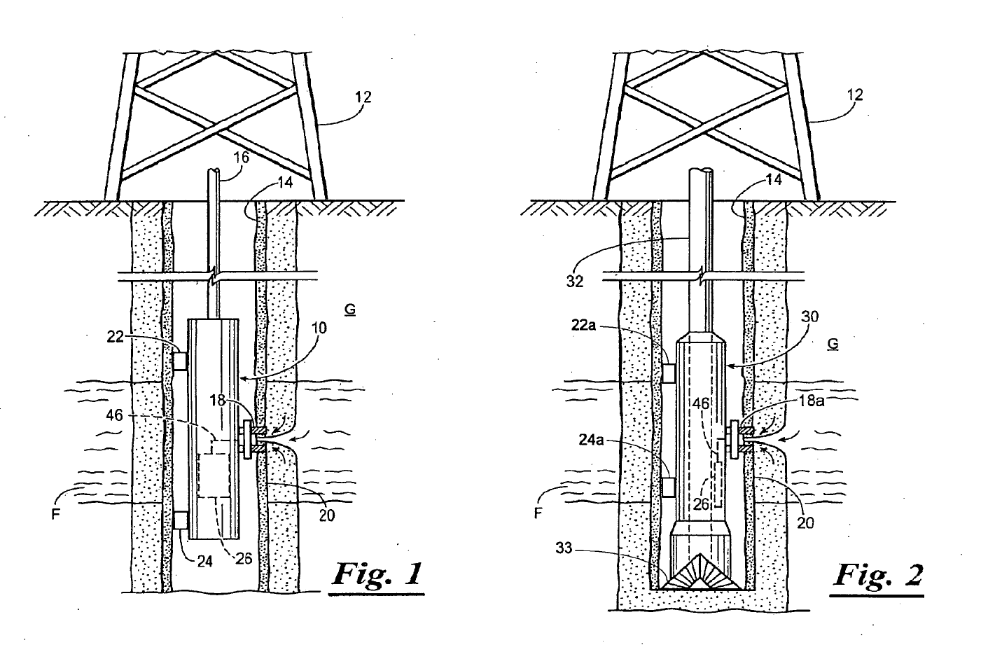

FIG. 1 shows a schematic, partial cross-sectional view of an example downhole tool 10. The example downhole tool 10 of FIG. 1 is suspended from a rig 12 into a wellbore 14 formed in a geologic formation G. The example downhole tool 10 can implement any type of downhole tool capable of performing formation evaluation, such as x-ray fluorescence, fluid analysis, fluid sampling, well logging, etc. The example downhole tool 10 of FIG. 1 is a wireline tool deployed from the rig 12 into the wellbore 14 via a wireline cable 16 and positioned adjacent to a particular geologic formation F.

To seal the example downhole tool 10 of FIG. 1 to a wall 20 of the wellbore 14 (hereinafter referred to as a “wall 20” or “wellbore wall 20”), the example downhole tool 10 includes a probe 18. The example probe 18 of FIG. 1 forms a seal against the wall 20 and draws fluid(s) from the formation F into the downhole tool 10 as depicted by the arrows. Backup pistons 22 and 24 assist in pushing the example probe 18 of the downhole tool 10 against the wellbore wall 20.

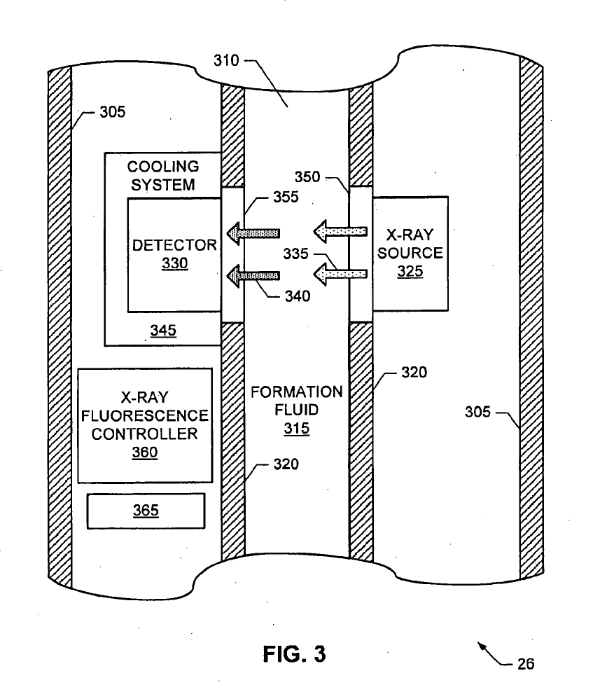

To detect elements such as sulfur, the example downhole tool 10 of FIG. 1 includes an x-ray fluorescence assembly 26 constructed in accordance with this disclosure. The example x-ray fluorescence assembly 26 of FIG. 1 performs x-ray fluorescence to detect, for example, sulfur present in downhole fluids, such as the formation fluids extracted or drawn from the formation F. The example x-ray fluorescence assembly 26 receives the formation fluid(s) from the probe 18 via an evaluation flowline 46. An example manner of implementing the example x-ray fluorescence assembly 26 of FIG. 1 is described below in connection with FIG. 3.

FIG. 2 shows a schematic, partial cross-sectional view of another example of a downhole tool 30. The example downhole tool 30 of FIG. 2 can be conveyed among one or more (or itself may be) of a measurement-while-drilling (MWD) tool, a logging-while-drilling (LWD) tool, or other type of downhole tool that are known to those skilled in the art. The example downhole tool 30 is attached to a drill string 32 and a drill bit 33 driven by the rig 12 to form the wellbore 14 in the geologic formation G.

To seal the example downhole tool 30 of FIG. 2 to the wall 20 of the wellbore 14, the downhole tool 30 includes a probe 18a. The example probe 18a of FIG. 2 forms a seal against the wall 20 and draws fluid(s) from the formation F into the downhole tool 30 as depicted by the arrows. Backup pistons 22a and 24a assist in pushing the example probe 18a of the downhole tool 30 against the wellbore wall 20. Drilling is stopped before the probe 18a is brought in contact with the wall 20.

To detect elements such as sulfur, the example downhole tool 30 of FIG. 2 also includes the example x-ray fluorescence assembly 26. The example x-ray fluorescence assembly 26 of FIG. 2 performs x-ray fluorescence to detect, for example, sulfur that is present in downhole fluids, such as the formation fluids extracted or drawn from the formation F. The example x-ray fluorescence assembly 26 receives the formation fluid(s) from the probe 18a via the evaluation flowline 46. An example manner of implementing the example x-ray fluorescence assembly 26 of FIG. 2 is described below in connection with FIG. 3.

While FIGS. 1 and 2 depict the x-ray fluorescence assembly 26 in the example downhole tools 10 and 30, the x-ray fluorescence assembly 26 may instead be provided or implemented at the wellsite (e.g., at the surface near the wellbore 14), and/or at an offsite facility for performing fluid tests. By positioning the x-ray fluorescence assembly 26 in the downhole tool 10, 30, real-time data may be collected concerning sulfur or other elements present in downhole fluids. However, it may also be desirable and/or necessary to test fluids at the surface and/or offsite locations. In such cases, the example x-ray fluorescence assembly 26 may be positioned in a housing transportable to a desired location. Alternatively, fluid samples may be taken to a surface or offsite location and tested in the x-ray fluorescence assembly 26 at such a location. Data and test results from various locations may be analyzed and compared.

FIG. 3 is a cross-sectional view of an example manner of implementing the example x-ray fluorescence assembly 26 of FIGS. 1 and 2. Additionally or alternatively, the example x-ray fluorescence assembly 26 of FIG. 3 may be used to detect sulfur or other elements that are present in formation fluids at the surface, at a wellsite, in a transportable lab, and/or in a fixed-location facility. Fluorescence is an optical phenomenon in which molecular absorption of a photon triggers the emission of another photon with, for example, a longer wavelength. In an example x-ray fluorescence method to detect sulfur in a formation fluid, the formation fluid is subjected to 5.9 kiloelectron volt (keV) x-rays and, in response to the 5.9 keV x-rays, any sulfur that is present within the formation fluid will fluoresce by emitting 2.3 keV x-rays. Thus, the detection and/or measurement of 2.3 keV x-rays emitted by the exposed formation fluid is indicative of the presence of sulfur within the formation fluid. The number of 2.3 keV x-rays corresponds to an amount of sulfur present within the formation fluid.

The example x-ray fluorescence assembly 26 of FIG. 3 comprises a housing 305 and a flowline and/or chamber 310 within and/or through which formation fluid(s) 315 can flow and/or be captured or trapped. The example flowline 310 of FIG. 3 is fluidly coupled to the example flowline 46 of FIGS. 1 and 2, and the example formation fluid 315 of FIG. 3 is provided to the x-ray fluorescence assembly 26 via the flowline 46. The example flowline 310 has a flowline wall 320 and one or more valves (not shown) that control the flow of the formation fluid 315 into and/or out of the flowline 310 and/or allow formation fluid 315 to be trapped within the flowline 310. In some examples, the flowline 310 has a cylindrical and/or rectangular cross-section.

To detect elements (e.g., sulfur) and/or compounds (e.g., sulfur dioxide) that are present in the formation fluid 315, the example x-ray fluorescence assembly 26 of FIG. 3 includes an x-ray excitation source 325 and one or more detectors, one of which is designated at reference numeral 330. The example excitation source 325 of FIG. 3 excites the formation fluid 315 and, thus, any elements or compounds present within the formation fluid 315 with x-rays 335, which under certain circumstances can cause elements and/or compounds in the formation fluid 315 to floresce (i.e., to emit and/or radiate x-rays 340). Whether or not fluorescence occurs depends on the type(s) of x-rays 335 emitted by the excitation source 325 and the type(s) of elements and/or compounds (if any) present in the formation fluid 315. The amount and/or type(s) of x-rays emitted by the formation fluid 315 and/or elements and/or compounds present in the formation fluid 315 can be measured by the example detector 330 of FIG. 3, and used to detect the presence of the elements and/or compounds. The type of x-rays 335 to excite the formation fluid 315 and the type of detector(s) 330 used depends on the type of elements and/or compounds that are to be detected. For example, when exposed to the x-rays 335, sulfur present within the formation fluid 315 emits characteristic Ka line (i.e., 2.3 keV) x-rays 340. The amount of 2.3 keV x-rays corresponds to amount of sulfur present within the formation fluid.

An example x-ray source 325 comprises a 55Fe (i.e., iron-55) chemical source that emits 5.9 keV x-rays 335. However, other types of x-ray sources 325 that emit x-rays that are effectively absorbed by sulfur or sulfur containing compounds, and which are able to operate at extreme pressures (e.g., 15,000 psi) and/or extreme temperatures (e.g., 150° C.) may be used. Preferably, the x-rays source 325 has a narrow emission spectrum and generates x-rays 335 have an adequate signal-to-noise ratio (SNR). In some examples, the x-ray source 325 includes a mechanical shutter (now shown) that can be operated (e.g., opened and closed) to selectively irradiate the formation fluid 315.

Example detectors 330 include, but are not limited to, those based on silicon (Si), lithium-drifted silicon (Si(Li)), a silicon PIN photodiode, germanium (Ge), cadmium telluride (CdTe), mercury iodide (HgI2), gallium nitride (GaN), silicon carbide (SiC), and/or chemical vapor deposition (CVD) grown diamond. Regardless of the type of material(s) used to implement the detector 330, the detector 330 preferably can operate in extreme ambient temperatures (e.g., 150° C.) and/or at extreme operating temperatures (e.g., 150° C.), have high sensitivity to 2.3 keV x-rays 340 pertinent to sulfur detection, and have low/no sensitivity to other (e.g., higher) energy x-rays and/or gamma-rays. A leak current in the detector 330 is caused by the x-rays 340 is the thermal-excitation of electron-hole pairs by the x-rays 340, and the population of the electron-hole pairs within the materials used to implement the detector 330. The leak current can be approximated by the following mathematical expression:

$$P ( T ) \approx {T}^{3 / 2} {e}^{( - \frac{{E}_{g}}{2 {K}_{B} T} )} ,$$

where E_{g} is the bandgap energy the detector 330, K_{B} is the Boltzmann constant, and T is temperature. The term E_{g}/T inside the exponential dominates the overall electron-hold populations. Thus, in order to reduce the carrier population, one can reduce the temperature T of the detector 330 and/or increase the bandgap E_{g} (i.e., using wider bandgap semiconductors). For example, CdTe (E_{g}=1.44 eV) has a larger bandgap than Si (E_{g}=1.11 eV) and Ge (E_{g}=0.66 eV), and has been reported to operate at 70° C. when used to implement the detector 330. With use of a cooling system 345, a CdTe-based detector 330 can be used at temperatures over 100° C. and possibly as high as 150° C. GaN and SiC have even larger bandgaps (E_{g}≈3 eV) and work at even higher temperatures. At an extreme, a vapor deposition grown diamond (E_{g}≈6 eV) is reported to operate at 250-300° C. The particular material(s) chosen to implement the example detector 330 depends on expected temperatures and the efficiency and/or capability of the example cooling system 345 to reduce the temperature of the detector 330.

To cool the example detector 330, the example x-ray fluorescence assembly 26 of FIG. 3 includes the example cooling system 345. The example cooling system 345 of FIG. 3 is used to reduce leakage current of the detector 330 by reducing the operating temperature of the detector 330. Example cooling systems 345 include, but are not limited to, Peltier cooling used locally within the x-ray fluorescence assembly near the detector 330, a Stirling engine to cool the whole x-ray fluorescence assembly within the example housing 305, and/or liquid Nitrogen (N). The particular type(s) of cooling system(s) 345 implemented depends on the expected ambient temperature(s) and/or the maximum operating temperature of the detector 330.

To allow the x-rays 335 to pass into the formation fluid 315, the example flowline wall 320 of FIG. 3 has a boron carbide crystal window 350. Likewise, to allow the x-rays 340 to pass from the formation fluid 315 onto the detector 330, the example flowline wall 320 of FIG. 3 has a second boron carbide crystal window 355. Boron carbide crystal is used to implement the example windows 350 and 355 of FIG. 3, as boron carbide crystal has low Z components making it relatively transparent (i.e., minimally absorptive) of the 5.9 keV x-rays 335 and the 2.3 keV x-rays 340, and can operate at extreme pressures (e.g., 15,000 psi) and extreme temperatures (e.g., 150° C.).

While in the illustrated example of FIG. 3, the windows 350 and 355 are shown on opposite sides of the flowline 310, they do not need to be so positioned. In general, the positions of the windows 350 and 355, and as a consequence the positions of the x-ray source 325 and the detector 330, may be selected based on any number and/or type(s) of criteria such as, for example, mechanical stability of the flowline wall 320, mechanical packaging issues, electrical control issues, etc.

To control the x-ray fluorescence assembly 26, the example x-ray fluorescence assembly 26 of FIG. 3 includes an x-ray fluorescence controller 360. The example x-ray fluorescence controller 360 of FIG. 3 (a) controls one or more valves to allow the formation fluid 315 to be trapped in the flowline 310, (b) controls the x-ray source 325 and the detector 330 to measure one or more values representative of the fluorescence of one or more elements and/or compounds present in the formation fluid 315. The example x-ray fluorescence controller 360 stores the measured values in any type and/or number of memory(-ies) and/or memory device(s), one of which is designated at reference numeral 365, for later retrieval. Additionally or alternatively, the measured values can be sent to a surface computer (not shown) using telemetry, and/or be analyzed by the example x-ray fluorescence controller 360 to determine the amount of an element and/or compound present in the formation fluid 315. The example x-ray fluorescence controller 360 may be implemented by hardware, software, firmware and/or any combination of hardware, software and/or firmware. Thus, for example, the example x-ray fluorescence controller 360 may be implemented by one or more circuit(s), programmable processor(s), application specific integrated circuit(s) (ASIC(s)), programmable logic device(s) (PLD(s)) and/or field-programmable PLD(s) (FPLD(s)), etc.

While an example manner of implementing the example x-ray fluorescence assembly 26 of FIGS. 1 and 2 has been illustrated in FIG. 3, one or more of the example interfaces, housing 305, flowline 310, flowline wall 320, windows 350 and 355, x-ray source 325, detector 330, cooling system 345, x-ray fluorescence controller 360 and/or memory 365 illustrated in FIG. 3 may be combined, divided, re-arranged, omitted, eliminated and/or implemented in any other way. Further, the x-ray fluorescence assembly 26 may include interfaces, housings, flowlines, flowline walls, windows, x-ray sources, detectors, cooling systems, controllers and/or memories instead of, or in addition to, those illustrated in FIG. 3 and/or may include more than one of any or all of the illustrated interfaces, housings, flowlines, flowline walls, windows, x-ray sources, detectors, cooling systems, controllers and/or memories.

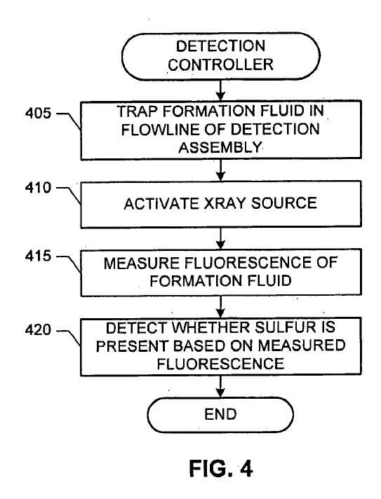

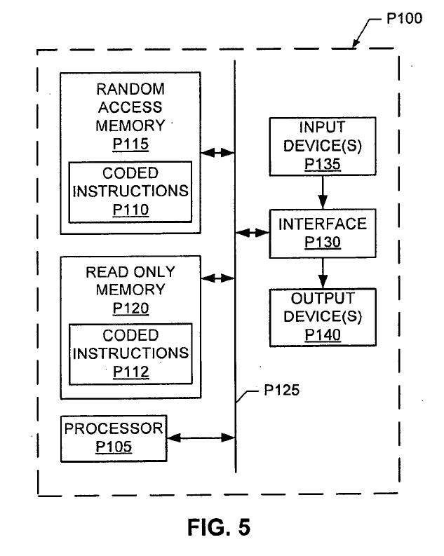

FIG. 4 illustrates an example process that may be carried out to implement the example x-ray fluorescence controller 360 and/or, more generally, to implement the example x-ray fluorescence assembly 26 of FIGS. 1-3. The example process of FIG. 4 may be carried out by a processor, a controller and/or any other suitable processing device. For example, the example process of FIG. 4 may be embodied in coded instructions stored on any tangible computer-readable medium such as a flash memory, a compact disc (CD), a digital versatile disc (DVD), a floppy disk, a read-only memory (ROM), a random-access memory (RAM), a programmable ROM (PROM), an electronically-programmable ROM (EPROM), and/or an electronically-erasable PROM (EEPROM), an optical storage disk, an optical storage device, magnetic storage disk, a magnetic storage device, and/or any other medium which can be used to carry or store program code and/or instructions in the form of machine-accessible and/or machine-readable instructions or data structures, and which can be accessed by a processor, a general-purpose or special-purpose computer, or other machine with a processor (e.g., the example processor platform P100 discussed below in connection with FIG. 5). Combinations of the above are also included within the scope of computer-readable media. Machine-readable instructions comprise, for example, instructions and/or data that cause a processor, a general-purpose computer, special-purpose computer, or a special-purpose processing machine to implement one or more particular processes. Alternatively, some or all of the example process of FIG. 4 may be implemented using any combination(s) of ASIC(s), PLD(s), FPLD(s), discrete logic, hardware, firmware, etc. Also, some or all of the example process of FIG. 4 may instead be implemented manually or as any combination of any of the foregoing techniques, for example, any combination of firmware, software, discrete logic and/or hardware. Further, many other methods of implementing the example operations of FIG. 4 may be employed. For example, the order of execution of the blocks may be changed, and/or one or more of the blocks described may be changed, eliminated, sub-divided, or combined. Additionally, any or all of the example process of FIG. 4 may be carried out sequentially and/or carried out in parallel by, for example, separate processing threads, processors, devices, discrete logic, circuits, etc.

The example process of FIG. 4 begins with the example x-ray fluorescence controller 360 controlling one or more valves to trap and/or capture the example formation fluid 315 in the example flowline 310 (block 405). The controller 360 activates the example x-ray source 325 to irradiate the formation fluid 315 with the x-rays 335 via the window 350 (block 410). For example, if a chemical-based x-ray excitation source 325 is used, the controller 360 may operate (e.g., open) a mechanical shutter to irradiate the formation fluid 315. The example detector 330 measures the amount of x-rays 340 emitted by elements (e.g., sulfur) and/or compounds within the formation fluid 310 that pass through the window 355 and fall incident upon the detector 330 (block 415). The controller 360 stores the fluorescence measurement(s) taken by the detector 330 in the memory 365, and/or determines whether and/or how much sulfur is present in the formation fluid 315 based on the measurements (block 420). Control then exits from the example process of FIG. 4.

FIG. 5 is a schematic diagram of an example processor platform P100 that may be used and/or programmed to implement the example controller 360 and/or the example x-ray fluorescence assembly 26 described herein. For example, the processor platform P100 can be implemented by one or more general-purpose processors, processor cores, microcontrollers, etc.

The processor platform P100 of the example of FIG. 5 includes at least one general-purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example process of FIG. 4 to implement the example methods and apparatus described herein.

The processor P105 is in communication with the main memory (including a ROM P120 and/or the RAM P115) via a bus P125. The RAM P115 may be implemented by dynamic random-access memory (DRAM), synchronous dynamic random-access memory (SDRAM), and/or any other type of RAM device, and ROM may be implemented by flash memory and/or any other desired type of memory device. Access to the memory P115 and the memory P120 may be controlled by a memory controller (not shown). The memory P115, P120 may be used to implement the example memory 365.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130. The example output device P140 may be used to, for example, control the example x-ray source 325. The example input device P135 may be used to, for example, collect measurements taken by the example detector 330.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A downhole x-ray fluorescence apparatus comprising:
a flowline comprising a flowline wall;
an x-ray source;
a boron carbide crystal window in the flowline wall to allow x-rays emitted by the x-ray source to pass into a formation fluid in the flowline; and
a detector to measure a value representative of a fluorescence of the formation fluid in response to the emitted x-rays.

2. A downhole x-ray fluorescence apparatus as defined in claim 1, further comprising a controller to detect whether sulfur is present in the formation fluid based on the measured value.

3. A downhole x-ray fluorescence apparatus as defined in claim 1, wherein the x-ray source and the detector are located outside of the flowline, and the formation fluid is trapped inside the flowline.

4. A downhole x-ray fluorescence apparatus as defined in claim 1, further comprising a second boron carbide crystal window in the flowline wall to allow the fluorescence of the formation fluid to be measured by the detector.

5. A downhole x-ray fluorescence apparatus as defined in claim 1, further comprising a cooling system to reduce an operating temperature of the detector.

6. A downhole x-ray fluorescence apparatus as defined in claim 5, wherein the cooling system comprises at least one of a Peltier cooler, a Stirling engine, or liquid Nitrogen.

7. A downhole x-ray fluorescence apparatus as defined in claim 1, wherein the x-ray source comprises a 55Fe source to emit 5.9 kiloelectron volt x-rays.

8. A downhole x-ray fluorescence apparatus as defined in claim 7, wherein the x-ray source further comprises a mechanical shutter.

9. A downhole x-ray fluorescence apparatus as defined in claim 1, wherein the detector is sensitive to 2.3 kiloelectron volt x-rays.

10. A downhole x-ray fluorescence apparatus as defined in claim 1, wherein the detector comprises at least one of silicon (Si), lithium-drifted silicon (Si(Li)), a silicon PIN photodiode, germanium (Ge), cadmium telluride (CdTe), mercury iodide (HgI2), gallium nitride (GaN), silicon carbide (SiC), or chemical vapor deposition (CVD) grown diamond.

11. A downhole x-ray fluorescence apparatus as defined in claim 1, wherein downhole apparatus is to operate at a pressure of 15,000 pounds per square inch and a temperature of 150 degrees Celsius.

12. A downhole x-ray fluorescence apparatus as defined in claim 1, wherein the x-rays are passed through the window into the formation fluid, and the value is measured while the flowline is positioned within a wellbore.

13. A method to detect sulfur in a formation fluid, the method comprising:
trapping the formation fluid in a flowline, the flowline having a boron carbide crystal window;
passing x-rays through the boron carbide crystal window into the trapped formation fluid;
measuring a value representative of a fluorescence of the trapped formation fluid in response to the x-rays; and
determining whether the sulfur is present in the formation fluid based on the measured value.

14. A method as defined in claim 13, wherein the formation fluid is trapped in the flowline, the x-rays are passed through the window into the formation fluid, and the value is measured while the flowline is positioned within a wellbore.

15. A method as defined in claim 13, further comprising an x-ray source to generate the x-rays, wherein the x-ray source and the detector are located outside of the flowline, and the formation fluid is trapped inside the flowline.

16. A method as defined in claim 13, further comprising operating a cooling system to reduce an operating temperature of the detector.

17. A method as defined in claim 16, wherein the cooling system comprises at least one of a Peltier cooler, a Stirling engine or liquid Nitrogen.

18. A method as defined in claim 13, wherein the detector is sensitive to 2.3 kiloelectron volt x-rays.

19. A method as defined in claim 13, wherein the detector comprises at least one of silicon (Si), lithium-drifted silicon (Si(Li)), a silicon PIN photodiode, germanium (Ge), cadmium telluride (CdTe), mercury iodide (HgI2), gallium nitride (GaN), silicon carbide (SiC), or chemical vapor deposition (CVD) grown diamond.
